(19) United States
(12) Patent Application Publication
(10) Pub. No.: US 2026/0121065 A1
(43) Pub. Date: Apr. 30, 2026

(54) ANODE ELECTRODE INCLUDING LITHIUM ALUMINUM AND LITHIUM METAL LAYERS FOR BATTERY CELLS

(71) Applicant: GM GLOBAL TECHNOLOGY OPERATIONS LLC., Detroit, MI (US)

(72) Inventors: Qili SU, Shanghai (CN); Zhe LI, Shanghai (CN); Xin ZHANG, Shanghai (CN); Xingcheng XIAO, Troy, MI (US); Haijing LIU, Shanghai (CN)

(21) Appl. No.: 19/299,014

(22) Filed: Aug. 13, 2025

(30) Foreign Application Priority Data
Oct. 30, 2024 (CN) 2024115333909

(51) Int. Cl. H01M 4/62; H01M 4/36; H01M 4/38; H01M 4/46; H01M 4/485; H01M 4/58; H01M 10/0568; H01M 10/0569; H01M 50/46

(52) U.S. Cl. CPC H01M 4/628; H01M 4/366; H01M 4/382; H01M 4/463; H01M 4/485; H01M 4/5825; H01M 10/0568; H01M 10/0569; H01M 50/46

(57) ABSTRACT

A battery cell includes C cathode electrodes, wherein each of the C cathode electrodes includes a cathode active material layer arranged on a cathode current collector, S separators, and A anode electrodes, where A, C and S are integers greater than one. Each of the A anode electrodes includes an anode active material layer arranged on an anode current collector. The anode active material layer comprises a lithium metal layer and a lithium aluminum layer arranged on a separator-facing side of the lithium metal layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly battery cells including an anode electrode with lithium aluminum and lithium metal layers.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes, wherein each of the C cathode electrodes includes a cathode active material layer arranged on a cathode current collector, S separators, and A anode electrodes, where A, C and S are integers greater than one. Each of the A anode electrodes includes an anode active material layer arranged on an anode current collector. The anode active material layer comprises a lithium metal layer and a lithium aluminum layer arranged on a separator-facing side of the lithium metal layer.

In other features, the lithium aluminum layer is formed in-situ by arranging an aluminum layer adjacent to the lithium metal layer to form the lithium aluminum layer. The lithium aluminum layer comprises in a range from 80.0 wt % to 99.99 wt % of lithium aluminum. A thickness of the lithium aluminum layer is in a range from 2 μm to 25 μm, and a thickness of the lithium metal layer is in a range from 20 μm to 50 μm.

In other features, the cathode active material layer comprises a cathode active material and a solid electrolyte. The S separators include the solid electrolyte. The cathode active material is selected from a group consisting of a layered oxide, an olivine-type oxide, a monoclinic-type oxide, a spinel type oxide, a tavorite, sulfur, Li2S, and combinations thereof. The cathode active material includes a coating layer selected from a group consisting of LiNbO3, Li3PO4, and combinations thereof.

In other features, the solid electrolyte is selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

In other features, the battery cell comprises a liquid-based battery cell, and the S separators include a polymer-based separator layer. A liquid electrolyte comprises one or more lithium salts and one or more solvents. The one or more lithium salts are selected from a group consisting of lithium hexafluorophosphate, lithium perchlorate, lithium tetrafluoroborate, lithium bis(trifluoromethane) sulfonylimide, lithium bis(fluorosulfonyl)imide, and combinations thereof. The one or more solvents are selected from a group consisting of an alkyl carbonate, an ester, a γ lactone, a chain structure ether, a cyclic ether, and/or combinations thereof.

In other features, the battery cell comprises a semi-solid state battery cell. The battery cell comprises an all-solid state battery cell. The anode active material layer further comprises an anodic aluminum oxide layer formed on the aluminum layer adjacent to the aluminum layer prior to in-situ lithiation.

In other features, the anode active material layer comprises in a range from 0.01 wt % to 10 wt % of the anodic aluminum oxide layer.

A method for manufacturing an anode electrode for a battery cell includes providing an aluminum foil layer; providing a lithium metal layer; providing an anode current collector; arranging the aluminum foil layer on the lithium metal layer, wherein the aluminum foil layer is lithiated in-situ by the lithium metal layer to form a lithium aluminum layer; arranging the aluminum foil layer and the lithium metal layer on the anode current collector to form an anode electrode; and arranging the anode electrode in a battery cell.

In other features, the method includes forming an anodic aluminum oxide layer on the aluminum foil layer prior to arranging the aluminum foil layer on the lithium metal layer. The lithium aluminum layer comprises in a range from 80.0 wt % to 99.99 wt % lithium aluminum, a thickness of the lithium aluminum layer is in a range from 2 μm to 25 μm, and a thickness of the lithium metal layer is in a range from 20 μm to 50 μm.

In other features, the battery cell comprises A of the anode electrode, C cathode electrodes, and S separators arranged in a stack, where A, C and S are integers greater than one. Each of the C cathode electrodes include a cathode active material layer arranged on a cathode current collector, the cathode active material layer comprises a cathode active material and a solid electrolyte, the cathode active material is selected from a group consisting of a layered oxide, an olivine-type oxide, a monoclinic-type oxide, a spinel type oxide, a tavorite, sulfur, Li2S, and combinations thereof, and the solid electrolyte is selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of battery cell including C cathode electrodes, A anode electrodes including a lithium aluminum layer, a lithium metal layer, and an anode current collector, and S separators according to the present disclosure;

FIG. 2 is a more detailed side cross section of an example of a battery cell including an anode electrode including a lithium aluminum layer, a lithium metal layer, and an anode current collector according to the present disclosure;

FIG. 3 is a graph illustrating an example of an x-ray diffraction pattern for aluminum foil and aluminum foil after contact with lithium foil according to the present disclosure;

FIG. 4 is a side cross section of an example of a liquid-based battery cell including an anode electrode including a lithium aluminum layer, a lithium metal layer, and an anode current collector according to the present disclosure;

FIG. 5 is a side cross section of an example of a semi-solid state battery cell including an anode electrode including a lithium aluminum layer, a lithium metal layer, and an anode current collector according to the present disclosure;

FIG. 6A illustrates a method for forming an anode electrode for a battery cell according to the present disclosure;

FIG. 6B is a side cross section of another example of a battery cell including the anode electrode of FIG. 6A according to the present disclosure;

FIG. 7A is a graph illustrating an example of voltage and specific capacity during initial formation of an ASSLMB without the LiAl layer at 0.1 C and 25° C.;

FIG. 7B is a graph illustrating an example of voltage and specific capacity during initial formation of an ASSLMB with the LiAl layer at 0.1 C and 25° C. according to the present disclosure;

FIG. 7C is a graph illustrating an example of discharge capacity as a function of cycles during cycling at 0.1 C and 25° C.;

FIG. 8A is a graph illustrating an example of voltage and specific capacity during initial formation of a battery cell with and without the LiAl layer at 0.05 C and 25° C.;

FIG. 8B is a graph illustrating an example of voltage and capacity during charge-discharge of a battery cell with and without the LiAl layer at 0.5 C and 25° C. according to the present disclosure; and

FIG. 8C is a graph illustrating an example of capacity retention as a function of cycles of a battery cell with and without the LiAl layer during cycling at 0.5 C and 25° C.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

All-solid-state lithium metal batteries (ASSLMBs) are becoming an important energy storage candidate for achieving both enhanced thermal stability and increased energy density. Solid electrolyte undergoes reductive decomposition and forms a passivating solid electrolyte interface (SEI) layer upon direct contact with a lithium metal layer. The passivating SEI layer continues to grow during cycling, which reduces the effective contact area and potentially accelerates dendritic lithium growth. Furthermore, factors such as non-uniform lithium plating/stripping behavior and physical defects promote dendritic lithium growth, which causes internal short circuits.

Battery cells according to the present disclosure include an anode electrode including a lithium aluminum (LiAl) layer that is formed in-situ via a spontaneous reaction between an aluminum layer and a lithium metal layer. The LiAl layer is lithiophilic and has a lower interface energy relative to lithium metal. The LiAl layer reduces interfacial resistance, homogenizes Li⁺ flux, and regulates uniform Li nucleation. As a result, electrochemical performance of ASSLMB including the LiAl layer suppresses the initial lithium dendritic growth and enables stable cell cycling.

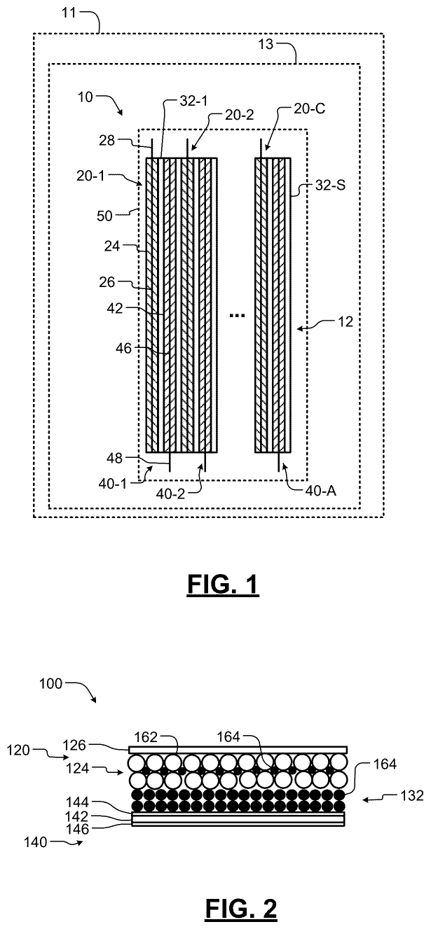

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 (including an LiAl layer and a lithium metal layer as described further below) arranged on an anode current collector 46. In some examples, the LiAl layer is formed in situ by arranging an aluminum layer on the lithium metal layer. In other examples, the LiAl layer is formed prior to arrangement adjacent to the lithium metal layer.

During charging/discharging, the A anode electrodes 40 and the C cathode electrodes 20 exchange lithium ions. In some examples, the cathode active material layers 24 comprise coatings including one or more active materials, solid electrolyte (for solid and semi-solid battery cells), one or more conductive additives, and/or one or more binder materials that are applied to the current collectors.

In some examples, the cathode current collector 26 comprises metal foil, metal mesh, perforated metal, 3 dimensional (3D) metal foam, and/or expanded metal. In some examples, the current collectors are made of one or more materials selected from a group consisting of stainless steel, aluminum, and/or alloys thereof.

External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2, an example of an ASSLMB 100 is shown. A cathode electrode 120 includes a cathode active material layer 124 arranged on a cathode current collector 126. In some examples, the cathode active material layer 124 includes cathode active material 162 and a solid electrolyte 164. In some examples, the cathode active material layer 124 also includes a conductive filler and/or binder.

A separator layer 132 (including the solid electrolyte 164, a conductive filler, and/or a binder) is arranged adjacent to the cathode electrode 120. In some examples, an anode electrode 140 includes an aluminum layer that is lithiated in-situ to form a lithium aluminum (LiAl) layer 144 on a lithium metal layer 142. In other examples, the anode electrode 140 includes a lithium aluminum layer 144 that is formed prior to arrangement on a lithium metal layer 142.

An aluminum layer or a preformed lithium aluminum layer 144 and the lithium metal layer 142 are arranged on an anode current collector 146 (e.g., a copper foil layer). If used, the aluminum layer (e.g., Al foil) spontaneously reacts with the lithium metal layer 142 (e.g., Li foil) in-situ to form the lithium aluminum layer 144. In some examples, the aluminum layer reacts with the lithium metal layer 142 at 25° C. for a period of 24 hours to form the lithium aluminum layer 144 without any electrochemical processing.

In some examples, the lithium aluminum layer 144 comprises in a range from 80.0 wt % to 99.99 wt % LiAl (e.g., 99.7% LiAl) after in-situ formation. In some examples, a thickness of the lithium aluminum layer 144 is in a range from 2 μm to 25 μm. In some examples, a thickness of the lithium aluminum layer 144 is in a range from 5 μm to 10 μm. In some examples, a thickness of the lithium metal layer 142 is in a range from 20 μm to 50 μm. In some examples, a thickness of the lithium metal layer 142 is in a range from 25 μm to 35 μm.

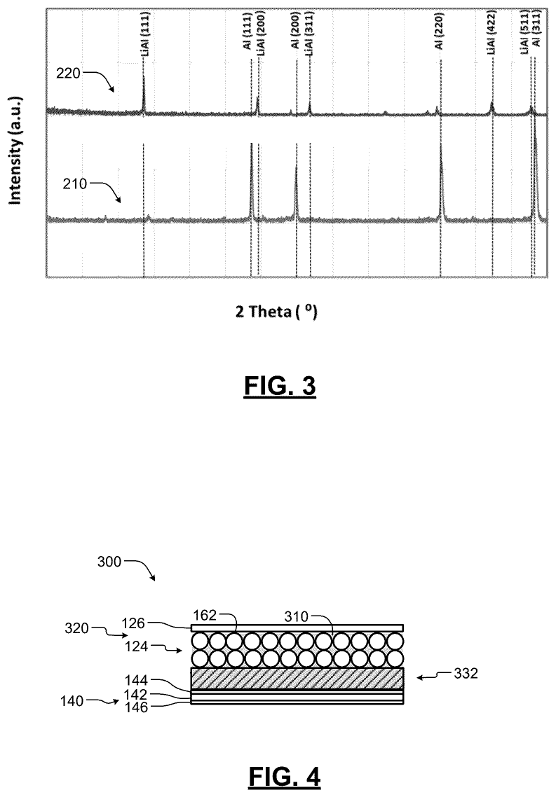

Referring now to FIG. 3, an x-ray diffraction pattern for aluminum foil before and after contact with lithium foil is shown. The Al foil (a phase, face-centered cubic (fcc)) is spontaneously converted to LiAl (β-phase, cubic), which can be confirmed by the standard data of LiAl crystal in the inorganic crystal structure database (ICSD). In addition, the Al foil expands in a direction perpendicular to the electrode/electrolyte interface, which can reduce the physical defects and/or suppress void formation at the interfaces. Based on the foregoing, the lithium aluminum layer 144 suppresses lithium dendritic growth and/or maintains a stable interface for ASSLMBs.

The lithium aluminum layer 144 is lithiophilic and has lower interface energy against Li, which can reduce the interfacial resistance, homogenize the Li⁺ flux, and regulate uniform Li nucleation. The lithium aluminum layer 144 also shields the lithium metal layer 142 from direct contact with sulfide solid electrolyte (if used), which attenuates side reactions.

Referring now to FIGS. 4 and 5, the lithium aluminum layer 144 can also be used in liquid-based and semi-solid-state lithium metal battery cells. In FIG. 4, a liquid-based battery cell 300 includes a cathode electrode 320 with the cathode active material layer 124 and the cathode current collector 126. The cathode active material layer 124 includes cathode active material 162, a liquid electrolyte 310, a conductive filler, and/or a binder. A separator layer 332 includes a polymer-based separator layer (and the liquid electrolyte 310). The anode electrode 140 includes the lithium aluminum layer 144 (preformed or formed in situ), the lithium metal layer 142, and the anode current collector 146.

In some examples, the liquid electrolyte 310 includes one or more lithium salts dissolved in one or more organic solvents, In some examples, the concentration of the lithium salt is greater than 1 molar (M). In some examples, the one or more lithium salts are selected from a group consisting of lithium hexafluorophosphate, lithium perchlorate, lithium tetrafluoroborate, lithium bis(trifluoromethane) sulfonylimide, lithium bis(fluorosulfonyl)imide, and combinations thereof. In some examples, the solvent is selected from a group consisting of an alkyl carbonate, an ester, a γ lactone, a chain structure ether, a cyclic ether, and/or combinations thereof.

Referring now to FIG. 5, a semi-solid state battery cell 400 includes a cathode electrode 420 including the cathode active material layer 124 arranged on the cathode current collector 126. The cathode active material layer 124 includes the cathode active material 162, the solid electrolyte 164, the liquid electrolyte 310, conductive filler, and/or binder. A separator layer 432 includes the solid electrolyte, conductive filler, and/or binder (and the liquid electrolyte 310). The anode electrode 140 includes the lithium aluminum layer 144 (preformed or formed in-situ), the lithium metal layer 142, and the anode current collector 146.

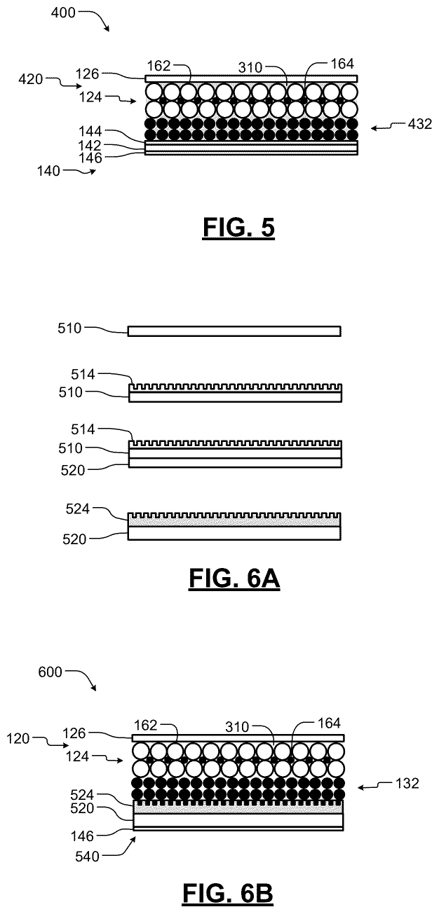

Referring now to FIG. 6A, another method for forming an anode electrode for a battery cell is shown. An aluminum layer 510 is coated with an anodic aluminum oxide (AAO) layer 514. The aluminum layer 510 and the anodic aluminum oxide layer 514 are laminated to a lithium metal layer 520 causing formation of a lithium aluminum layer 524. In some examples, the anodic aluminum oxide comprises 0.01 wt % to 10 wt % of the aluminum layer 510 and the anodic aluminum oxide layer 514.

Referring now to FIG. 6B, another example of an ASSLMB 600 is shown. A cathode electrode 120 includes a cathode active material layer 124 arranged on a cathode current collector 126. The cathode active material layer 124 includes cathode active material 162, a solid electrolyte 164, a conductive filler, and/or a binder. The separator layer 132 (including the solid electrolyte 164, a conductive filler, and/or a binder) is arranged adjacent to the cathode electrode 120. The anode electrode 540 includes the lithium aluminum layer 524, the lithium metal layer 520, and the anode current collector 146.

In some examples, the cathode electrode is prepared using a wet-coating process, a dry-film process, a dry-powder coating process, and/or other suitable processes. In some examples, the cathode active material layer includes cathode active material in a range from 30 wt % to 98 wt %, a solid electrolyte in a range from 1 wt % to 50 wt %, a conductive filler in a range from 1 wt % to 30 wt %, and/or a binder in a range from 0.1 wt % to 10 wt %.

In some examples, the cathode active material comprises a layered oxide (e.g., LiMeO₂), an olivine-type oxide (e.g., LiMePO₄), a monoclinic-type oxide (e.g., Li₃Me₂(PO₄)₃), a spinel type oxide (e.g., LiMe₂O₄), a tavorite (e.g., LiMeSO₄F, and/or LiMePO₄F), where Me is a transition metal (e.g., Co, Ni, Mn, Fe, Al, V, or a combination thereof), sulfur, Li₂S, and combinations thereof. In some examples, the cathode active material includes a coating layer (e.g., LiNbO₃ and Li₃PO₄).

In some examples, the binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), poly(vinylidene fluoride-co-hexafluoropropylene) (PVDF-HFP), polyethylene oxide (PEO), polyacrylonitrile (PAN), poly(acrylic acid) (PAA), styrene butadiene styrene copolymer(SBS), and combinations thereof.

In some examples, the solid electrolyte in FIGS. 2, 5 and 6B is selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system, (Li_{3.25}Ge_{0.25}P_{0.75}S₄ and Li₁₀GeP₂S₁₂), Li₂S—P₂S₅—LiX system (where X=F, Cl, Br, I), (Li₆PS₅Br, Li₆PS₅Cl, L₇P₂S₈I and Li₄PS₄I), Li₂S—As₂S₅—SnS₂ system, (Li_{3.833}Sn_{0.833}As_{0.16684}) system, Li₂S—P₂S₅—Al₂S₃ system, Li₂S—LiX—SiS₂ system (where X=F, Cl, Br, I), 0.4LiI-0.6Li₄SnS₄, and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7} Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of the halide-based sulfide electrolyte include Li₃YCl₆, Li₃InCl₆, Li₃YBr₆, LiI, Li₂CdCl₄, Li₂MgCl₄, Li₂Cd₁₄, Li₂Zn₁₄, and Li₃OCl. Examples of the hydride-based sulfide electrolyte include LiBH₄, LiBH₄—LiX (X=Cl, Br, or I), LiNH₂, Li₂NH, LiBH₄—LiNH₂, and Li₃AlH₆.

Examples of oxide-based solid electrolyte include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃, LISICON type (e.g., Li₂₊₂ₓZn₁₋ₓGeO₄).

Examples of metal-doped or aliovalent-substituted oxide solid electrolyte include Al, Nb or Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂. Examples of nitride-based solid electrolyte include Li₃N, Li₇PN₄, LiSi₂N₃. Examples of borate-based solid electrolyte include Li₂B₄O₇, Li₂O—B₂O₃—P₂O₅.

In some examples, the separator layer 132 includes solid electrolyte in a range from 20 wt % to 100 wt %, a filler in a range from 0 wt % to 30 wt %, and binder in a range from 0 wt % to 20 wt %. In some examples, the filler of the separator layer 132 is selected from a group consisting of oxide particles (e.g., SiO₂, Al₂O₃, TiO₂, and ZrO₂), a polymer framework (e.g., polypropylene (PP), polyethylene (PE), lithium salts (e.g., LiTFSI, LiBF₄), and combinations thereof.

In some examples, the binder material is selected from a group consisting of poly(vinylidene fluoride) (PVDF), poly(vinylidene fluoride-co-hexafluoropropylene) (PVDF-HFP), poly(tetrafluoroethylene) (PTFE), sodium carboxymethyl cellulose (CMC), styrene-butadiene rubber (SBR), nitrile butadiene rubber (N BR), styrene ethylene butylene styrene copolymer (SEBS), poly(ethylene oxide) (PEO), polyvinylpyrrolidone (PVP), poly(vinyl alcohol), poly(acrylic acid) (PAA), and combinations thereof. In some examples, the separator layer has a thickness in a range from 5 μm to 200 μm.

In some examples, the separator layer for the liquid-based battery cell in FIG. 4 has a porosity in a range from 30% to 80%. In some examples, the porosity is in a range from 45% to 60%. In some examples, the separator layer includes a material selected from a group consisting of polyolefin, cellulose, polyvinylidene fluoride (PVDF), porous polyimide, a ceramic-coated material, and a high-temperature-stable polymer-based material.

Examples of polyolefin separators include polyacetylene: polypropylene (PP), polyethylene (PE), a dual layer type (PP-PE), and three-layer type (PP-PE-PP). Examples of ceramic-coated separators include SiO₂ coated PE. Examples of high-temperature-stable polymer-based separators include polyimide (PI) nanofiber-based nonwovens, nano-sized Al₂O₃ and poly(lithium 4-styrenesulfonate)-coated polyethylene membrane, SiO₂ coated polyethylene (PE), co-polyimide-coated polyethylene, polyetherimide-based (PEI) separators (e.g., bisphenol-acetone diphthalic anhydride (BPADA) and para-phenylenediamine), an expanded polytetrafluoroethylene-reinforced polyvinylidene fluoride hexafluoropropylene separator, a sandwich-structured PVDF/PMIA/PVDF nanofibrous separator, and combinations thereof.

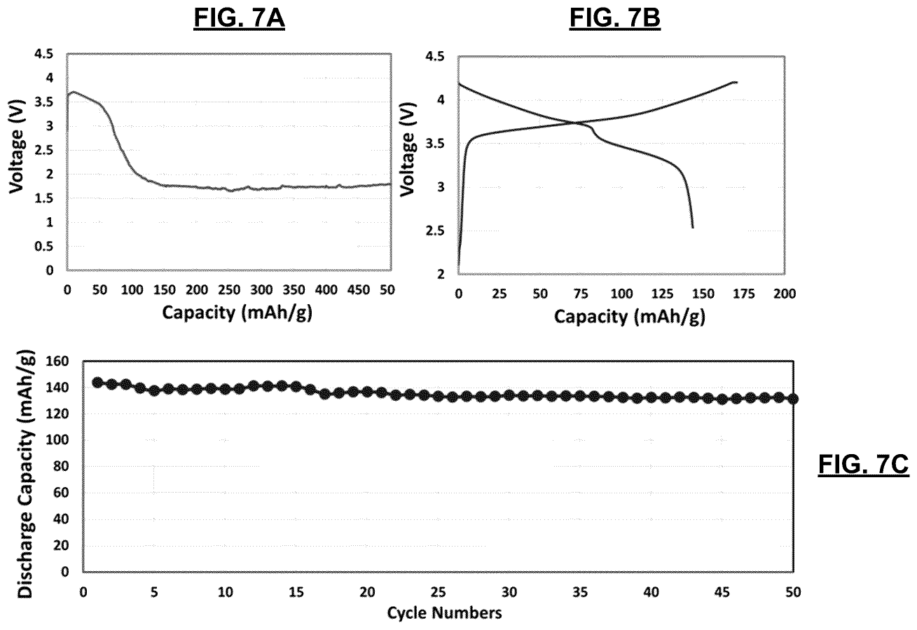

Referring now to FIGS. 7A to 7C, performance is shown for an ASSLMB including solid electrolyte comprising Li₆PS₅Cl and cathode active material comprising NCM721. In FIG. 7A, the ASSLMB without the LiAl layer is formed at 0.1 C and 25° C. and experiences a short circuit. In FIG. 7B, voltage and specific capacity are shown during initial formation of an ASSLMB with the LiAl layer at 0.1 C and 25° C. In FIG. 7C, the ASSLMB with the LiAl layer is shown during cycling at 0.1 C and 25° C. The in-situ-formed LiAl layer provides protection by effectively suppressing the initial lithium dendritic growth and enabling stable cell cycling at 0.1 C.

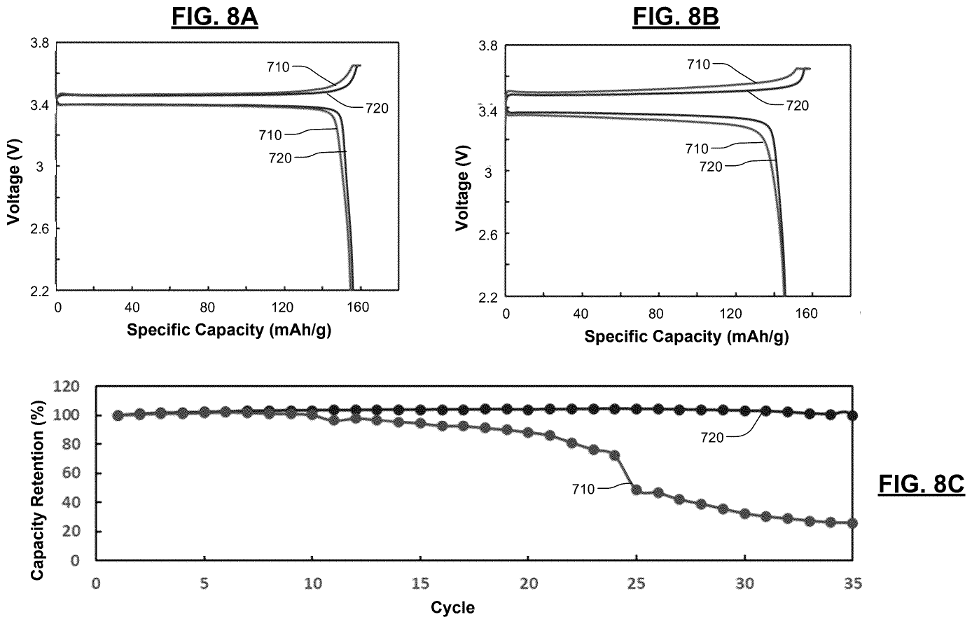

Referring now to FIGS. 8A to 8C, performance is shown for a liquid-based battery cell including liquid electrolyte comprising 1.2 M LiPF₆ in carbonate, a polymer separator, and cathode active material comprising lithium iron phosphate (LFP). In FIG. 8A, voltage and specific capacity are shown during initial formation of a battery cell without the LiAl layer at 710 and with the LiAl layer at 720 at 0.05 C and 25° C. In FIG. 8B, voltage and capacity are shown during charge-discharge of a battery cell with and without the LiAl layer at 0.5 C and 25° C. In FIG. 8C, capacity retention is shown as a function of cycles of a battery cell with and without the lithium aluminum layer during cycling at 0.5 C and 25° C. The in-situ-formed lithium aluminum layer increases the cell cycling stability at 0.5 C for liquid-based lithium metal battery.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A battery cell comprising:
C cathode electrodes, wherein each of the C cathode electrodes includes a cathode active material layer arranged on a cathode current collector;
S separators; and
A anode electrodes, where A, C and S are integers greater than one,
wherein each of the A anode electrodes includes an anode active material layer arranged on an anode current collector, and
wherein the anode active material layer comprises a lithium metal layer and a lithium aluminum layer arranged on a separator-facing side of the lithium metal layer.

2. The battery cell of claim 1, wherein the lithium aluminum layer is formed in-situ by arranging an aluminum layer adjacent to the lithium metal layer to form the lithium aluminum layer.

3. The battery cell of claim 1, wherein:
the lithium aluminum layer comprises in a range from 80.0 wt % to 99.99 wt % of lithium aluminum,
a thickness of the lithium aluminum layer is in a range from 2 μm to 25 μm, and
a thickness of the lithium metal layer is in a range from 20 μm to 50 μm.

4. The battery cell of claim 1, wherein:
the cathode active material layer comprises a cathode active material and a solid electrolyte; and
the S separators include the solid electrolyte.

5. The battery cell of claim 4, wherein the cathode active material is selected from a group consisting of a layered oxide, an olivine-type oxide, a monoclinic-type oxide, a spinel type oxide, a tavorite, sulfur, Li₂S, and combinations thereof.

6. The battery cell of claim 5, wherein the cathode active material includes a coating layer selected from a group consisting of LiNbO₃, Li₃PO₄, and combinations thereof.

7. The battery cell of claim 4, wherein the solid electrolyte is selected from a group consisting of pseudobinary sulfide, pseudoternary sulfide, pseudoquaternary sulfide, an oxide-based solid electrolyte, a metal-doped or aliovalent oxide, a nitride-based solid electrolyte, a halide-based solid electrolyte, a hydride-based solid electrolyte, a borate-based solid electrolyte, and combinations thereof.

8. The battery cell of claim 1, wherein:
the battery cell comprises a liquid-based battery cell, and
the S separators include a polymer-based separator layer.

9. The battery cell of claim 8, further comprising a liquid electrolyte comprising one or more lithium salts and one or more solvents.

10. The battery cell of claim 9, wherein the one or more lithium salts are selected from a group consisting of lithium hexafluorophosphate, lithium perchlorate, lithium tetrafluoroborate, lithium bis(trifluoromethane) sulfonylimide, lithium bis(fluorosulfonyl)imide, and combinations thereof.

11. The battery cell of claim 9, wherein the one or more solvents are selected from a group consisting of an alkyl carbonate, an ester, a γ lactone, a chain structure ether, a cyclic ether, and/or combinations thereof.

12. The battery cell of claim 1, wherein the battery cell comprises a semi-solid state battery cell.

13. The battery cell of claim 1, wherein the battery cell comprises an all-solid state battery cell.

14. The battery cell of claim 2, wherein the anode active material layer further comprises an anodic aluminum oxide layer formed on the aluminum layer adjacent to the aluminum layer prior to in-situ lithiation.

15. The battery cell of claim 14, wherein the anode active material layer comprises in a range from 0.01 wt % to 10 wt % of the anodic aluminum oxide layer.

16. A method for manufacturing an anode electrode for a battery cell, comprising:
providing an aluminum foil layer;
providing a lithium metal layer;
providing an anode current collector;
arranging the aluminum foil layer on the lithium metal layer, wherein the aluminum foil layer is lithiated in-situ by the lithium metal layer to form a lithium aluminum layer;
arranging the aluminum foil layer and the lithium metal layer on the anode current collector to form an anode electrode; and
arranging the anode electrode in a battery cell.

17. The method of claim 16, further comprising forming an anodic aluminum oxide layer on the aluminum foil layer prior to arranging the aluminum foil layer on the lithium metal layer.

18. The method of claim 16, wherein:
the lithium aluminum layer comprises in a range from 80.0 wt % to 99.99 wt % lithium aluminum,
a thickness of the lithium aluminum layer is in a range from 2 μm to 25 μm, and
a thickness of the lithium metal layer is in a range from 20 μm to 50 μm.

19. The method of claim 16, wherein the battery cell comprises A of the anode electrode, C cathode electrodes, and S separators arranged in a stack, where A, C and S are integers greater than one.

20. A battery cell for a battery pack of a vehicle, comprising:
C cathode electrodes, wherein each of the C cathode electrodes includes a cathode active material layer arranged on a cathode current collector;
S separators; and
A anode electrodes, where A, C and S are integers greater than one,
wherein each of the A anode electrodes includes an anode active material layer arranged on an anode current collector,
wherein the anode active material layer comprises a lithium metal layer and a lithium aluminum layer arranged on a separator-facing side of the lithium metal layer,
wherein the lithium aluminum layer comprises in a range from 80.0 wt % to 99.99 wt % of lithium aluminum, a thickness of the lithium aluminum layer is in a range from 2 μm to 25 μm, and a thickness of the lithium metal layer is in a range from 20 μm to 50 μm.
